(19) United States
(12) Patent Application Publication
(10) Pub. No.: US 2004/0220731 A1
(43) Pub. Date: Nov. 4, 2004

(54) Apparatus for recording global positioning system coordinates of components of a utility

(75) Inventors: Layne Daniel Tucker, Grande Prairie (CA); Peter William Lylick, St. Albert (CA)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Guardian Angel Protection Inc.

(21) Appl. No.: 10/714,091

(22) Filed: Nov. 13, 2003

(30) Foreign Application Priority Data
Mar. 24, 2003 (CA) 2,423,148

(51) Int. Cl. G01C 21/34

(52) U.S. Cl. 701/213; 701/215

(57) ABSTRACT

An apparatus for recording global positioning system co-ordinates of components of a utility, includes a portable controller having a memory and a global positioning system (GPS) co-ordinate device coupled to the controller. The GPS co-ordinate device dynamically provides GPS co-ordinates to the controller as positioning of the GPS co-ordinate device changes location. A display is associated with the controller. The display displays the GPS co-ordinates of the GPS co-ordinate device on a scrolling grid of global positioning system co-ordinates. A utility identifier database is housed in the memory of the controller. The utility identifier database contains numerous symbols. Each symbol represents a particular component of a utility. An input device is coupled to the controller for selecting the symbol from the utility identifier database which identifies the component of the utility. The controller places the selected symbol on the scrolling grid of GPS co-ordinates and stores the symbol with GPS co-ordinates in memory for subsequent recall.

### FIELD OF THE INVENTION

The present invention relates to an apparatus for recording global positioning system co-ordinates of components of a utility

### BACKGROUND OF THE INVENTION

A variety of sophisticated devices exist to assist in determining global positioning system (GPS) co-ordinates for an object. One of the current leaders in the industry is Trimble Navigation. Trimble Navigation sells their devices under such Trade Marks as: TERRASYNC, GISTSCE, ASSET SURVEYOR, and GPS PATHFINDER.

Co-ordinate data is collected in the field using the devices of Trimble Navigation. The co-ordinate data gathered in the field can subsequently be entered onto a map by the user.

### SUMMARY OF THE INVENTION

What is required is an apparatus is simple to use and will permit more rapid recording of global positioning system co-ordinates of components of a utility.

According to the present invention there is provided an apparatus for recording global positioning system co-ordinates of components of a utility, which includes a portable controller having a memory and a global positioning system (GPS) co-ordinate device coupled to the controller. The GPS co-ordinate device dynamically provides GPS co-ordinates to the controller as positioning of the GPS co-ordinate device changes location. A display is associated with the controller. The display displays the GPS co-ordinates of the GPS co-ordinate device on a scrolling grid of global positioning system co-ordinates. A utility identifier database is housed in the memory of the controller. The utility identifier database contains numerous symbols. Each symbol represents a particular component of a utility. An input device is coupled to the controller for selecting the symbol from the utility identifier database which identifies the component of the utility. The controller places the selected symbol on the scrolling grid of GPS co-ordinates and stores the symbol with GPS co-ordinates in memory for subsequent recall.

As will be hereinafter further described, when the apparatus described above is used, the information gathered in the field is automatically in usable form.

The resulting display can be made more user friendly by having the scrolling grid of GPS co-ordinates superimposed over a geographical map on which is displayed such things as road infrastructure.

### BRIEF DESCRIPTION OF THE DRAWINGS

These and other features of the invention will become more apparent from the following description in which reference is made to the appended drawings, the drawings are for the purpose of illustration only and are not intended to in any way limit the scope of the invention to the particular embodiment or embodiments shown, wherein:

FIG. 1 is a perspective view of an apparatus constructed in accordance with the teachings of the invention.

FIG. 2 is a detailed front elevation view of the display on the apparatus illustrated in FIG. 1, displaying a utility.

FIG. 3 is a detailed front elevation view of an enhanced display for the apparatus illustrated in FIG. 1, displaying a geographical map.

### DETAILED DESCRIPTION OF THE PREFERRED EMBODIMENT

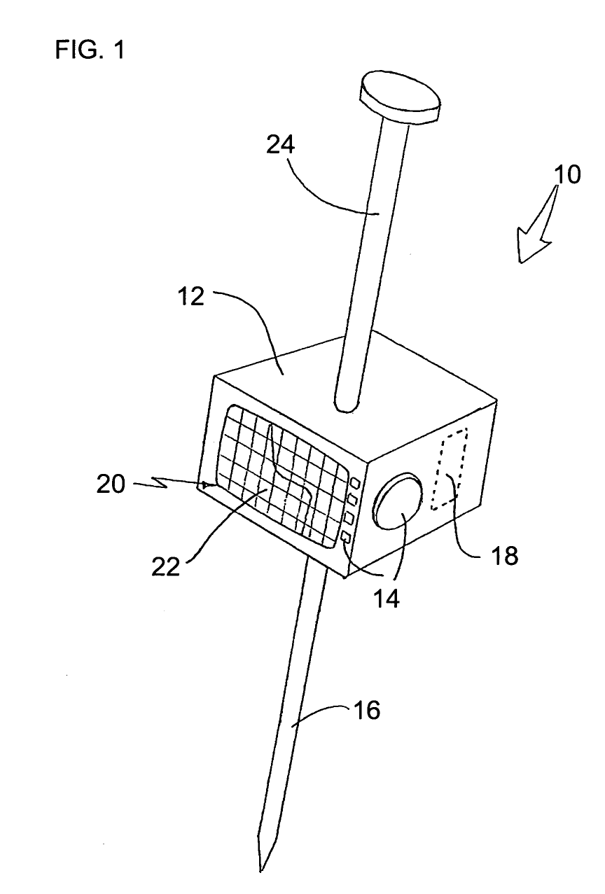

The preferred embodiment, an apparatus for recording global positioning system co-ordinates of components of a utility generally identified by reference numeral 10, will now be described with reference to FIGS. 1 through 3.

Structure and Relationship of Parts:

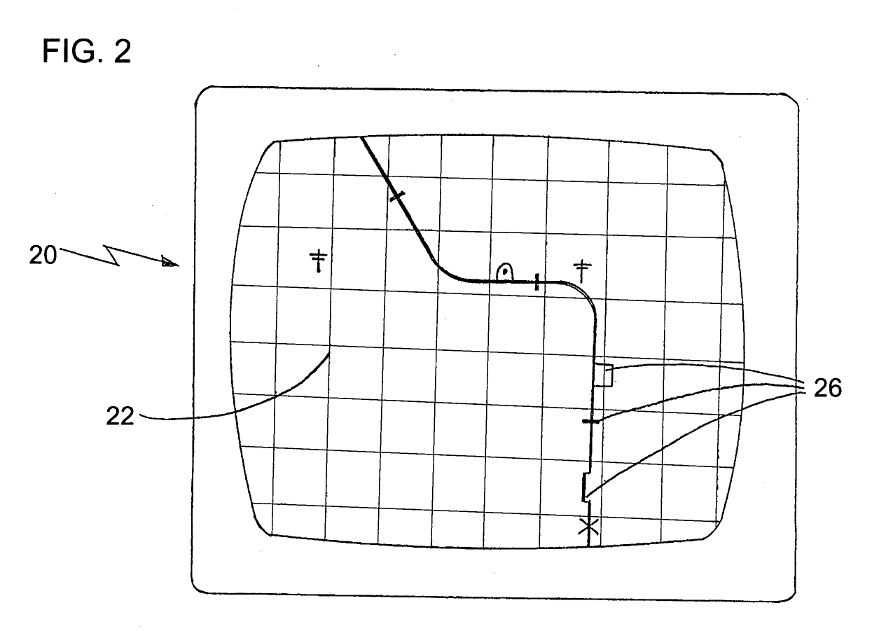

Referring to FIG. 1, apparatus 10 has a portable controller 12 having a memory. A global positioning system (GPS) co-ordinate device 24 is coupled to controller 12. As illustrated, GPS co-ordinate device 24 includes a ground rod 16 which is placed over a component of a utility to be identified. GPS co-ordinate device 24 dynamically provides GPS co-ordinates to controller 12, as positioning of GPS co-ordinate device 24 changes location. A display 20 is associated with controller 12. Display 20 displays the GPS co-ordinates of GPS co-ordinate device 24 on a scrolling grid 22 of global positioning system co-ordinates. A utility identifier database, generally indicated by reference numeral 18, is housed in the memory of controller 12. Utility identifier database contains numerous symbols, as will hereinafter further described and illustrated. Each symbol represents a particular component of a utility. Several input device 14 are coupled to the controller for selecting the symbol from utility identifier database 18 which identifies the component of the utility. Referring to FIG. 2, controller 12 places the selected symbols 26 on scrolling grid 22 of GPS co-ordinates and stores the symbol with GPS co-ordinates in memory for subsequent recall.

Table of Representative Utility Identifiers

| | |
|---|---|
| POWER POLE: | 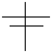 |
| FIRE HYDRANT: | 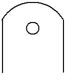 |
| VALVE: | 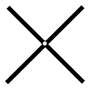 |
| WELD: | 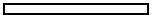 |
| RISER/ABOVE GROUND: | 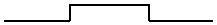 |
| PIPE: | 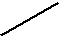 |
| CORNER: | 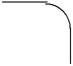 |
| CATHODE BED: | 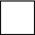 |

Operation:

The use and operation of apparatus for mapping utilities 10 will now be described with reference to FIGS. 1 and 2. Referring to FIG. 1, ground rod 16 is placed over a component of a utility. GPS co-ordinate device 24 provides GPS co-ordinates to controller 12 for that particular component. A symbol 26 is selected from utility identifier database 18 using input device 14. Referring to FIG. 2, controller 12 places the selected symbol 26 on scrolling grid 22 of selected GPS co-ordinates displayed on display 20. As a result, a user, by observing display 20, can accurately ascertain not only the positioning of the utility but can ascertain precisely the location of various components of the utility such as fire hydrants, power poles, risers and the like.

Variations:

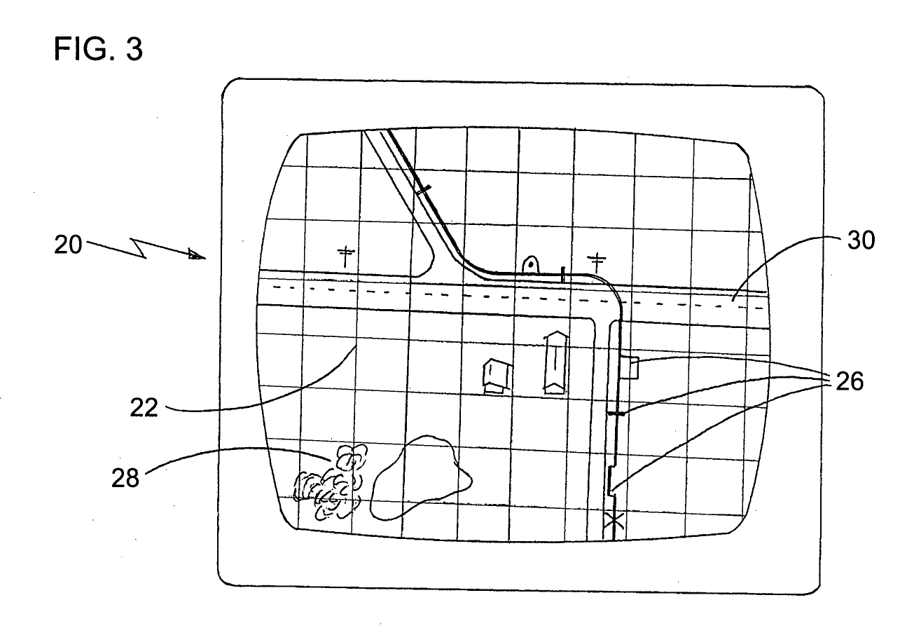

Referring to FIG. 3, display 20 can be made more user friendly by having scrolling grid 22 of GPS co-ordinates superimposed over a geographical map 28 on which is displayed such things as road infrastructure 30.

It will be appreciated that the co-ordinates provide an accurate indication as to latitude and longitude. When desired, the co-ordinates can also provide an indication of altitude or depth.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiment without departing from the spirit and scope of the invention as hereinafter defined in the claims.

The embodiments of the invention in which an exclusive property or privilege is claimed are defined as follows:

1. An apparatus for recording global positioning system co-ordinates of components of a utility, comprising:
a portable controller having a memory;
a global positioning system (GPS) co-ordinate device coupled to the controller, the GPS co-ordinate device dynamically providing GPS co-ordinates to the controller as positioning of the GPS co-ordinate device changes location;
a display associated with the controller, the display displaying the GPS co-ordinates of the GPS co-ordinate device on a scrolling grid of global positioning system co-ordinates;
a utility identifier database housed in the memory of the controller, the utility identifier database containing numerous symbols, each symbol representing a particular component of a utility; and
an input device to the controller for selecting the symbol from the utility identifier database which identifies the component of the utility, the controller placing the selected symbol on the scrolling grid of GPS co-ordinates and storing the symbol with GPS co-ordinates in memory for subsequent recall.

2. The apparatus as defined in claim 1, wherein the scrolling grid of GPS co-ordinates is superimposed over a geographical map.

3. The apparatus as defined in claim 1, wherein road infrastructure is displayed on the geographical map.
